(19) United States
(12) Patent Application Publication
(10) Pub. No.: US 2008/0264018 A1
(43) Pub. Date: Oct. 30, 2008

(54) INERTIAL GAS-LIQUID SEPARATOR WITH SLOT NOZZLE

(76) Inventor: Peter K. Herman, Stoughton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/740,369

(22) Filed: Apr. 26, 2007

(51) Int. Cl. B01D 45/08

(52) U.S. Cl. 55/462

(57) ABSTRACT

An inertial gas-liquid impactor separator has a nozzle accelerating a gas-liquid stream therethrough effecting liquid particle separation. The nozzle is provided by an elongated slot.

### BACKGROUND AND SUMMARY

The invention relates to inertial gas-liquid separators for removing and coalescing liquid particles from a gas-liquid stream, including in engine crankcase ventilation separation applications, including closed crankcase ventilation (CCV) and open crankcase ventilation (OCV).

Inertial gas-liquid separators are known in prior art, for example U.S. Pat. No. 6,290,738, incorporated herein by reference. Liquid particles are removed from a gas-liquid stream by accelerating the stream or aerosol to high velocities through nozzles or orifices and directing same against an impactor, typically causing a sharp directional change, effecting the noted liquid separation. Such inertial impactors have various uses, including in oil separation applications for blowby gases from the crankcase of an internal combustion engine.

The present invention arose during continuing development efforts relating to the above noted inertial gas-liquid separators.

### BRIEF DESCRIPTION OF THE DRAWINGS

### Prior Art

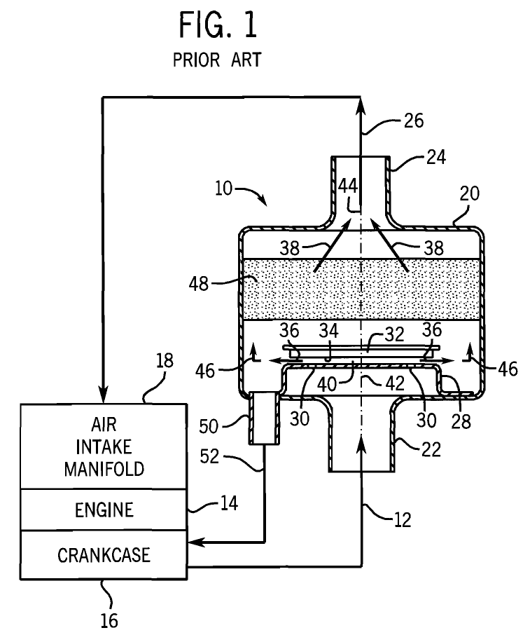

FIGS. 1-6 are taken from incorporated U.S. Pat. No. 6,290,738.

FIG. 1 is a schematic side sectional view of an inertial gas-liquid separator in an engine crankcase ventilation separation application.

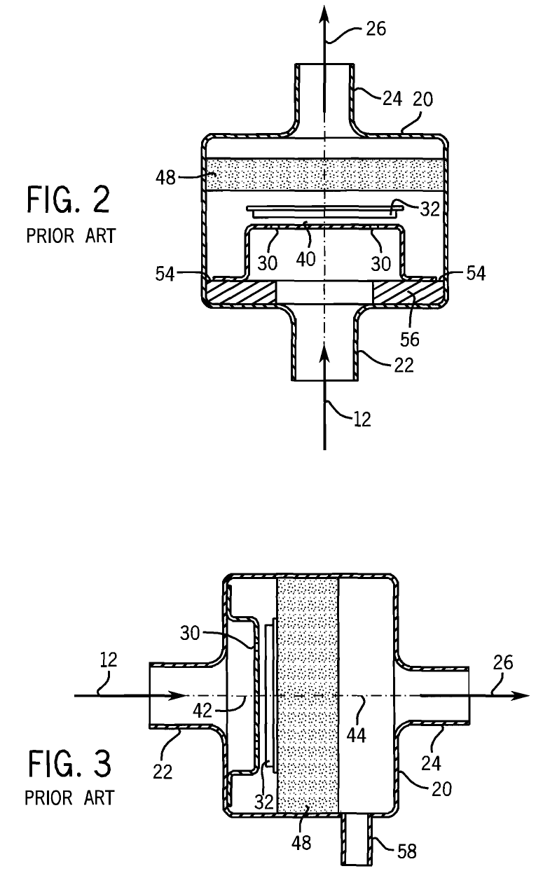

FIG. 2 is like FIG. 1 and shows another embodiment.

FIG. 3 is like FIG. 1 and shows another embodiment.

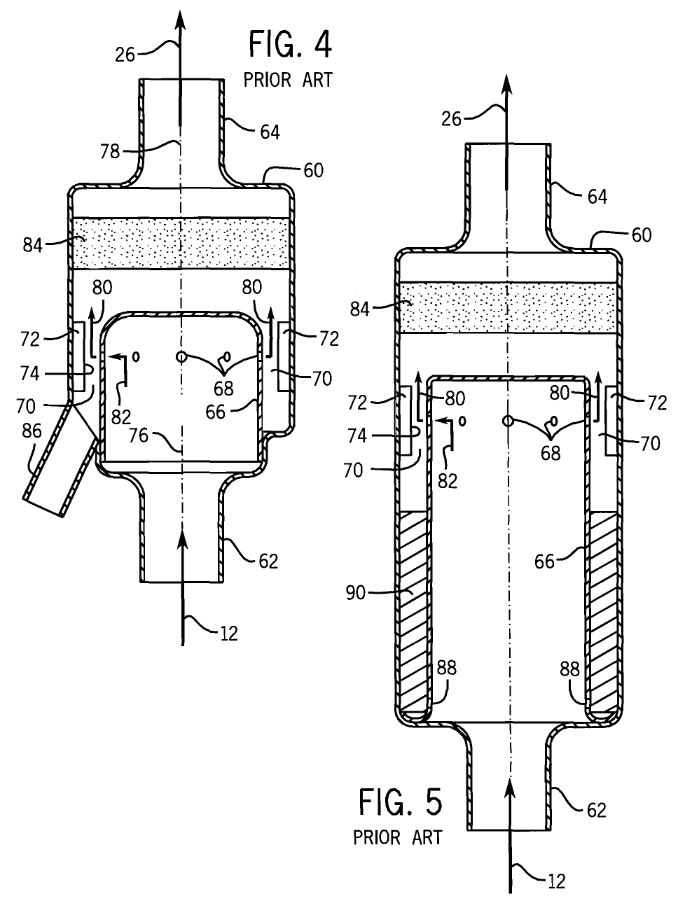

FIG. 4 is like FIG. 1 and shows another embodiment.

FIG. 5 is like FIG. 1 and shows another embodiment.

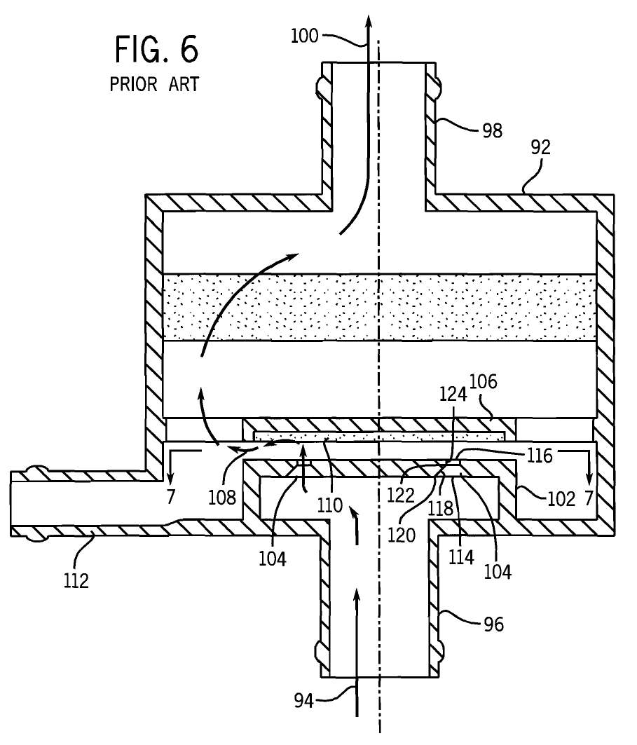

FIG. 6 shows a further embodiment.

### Present Application

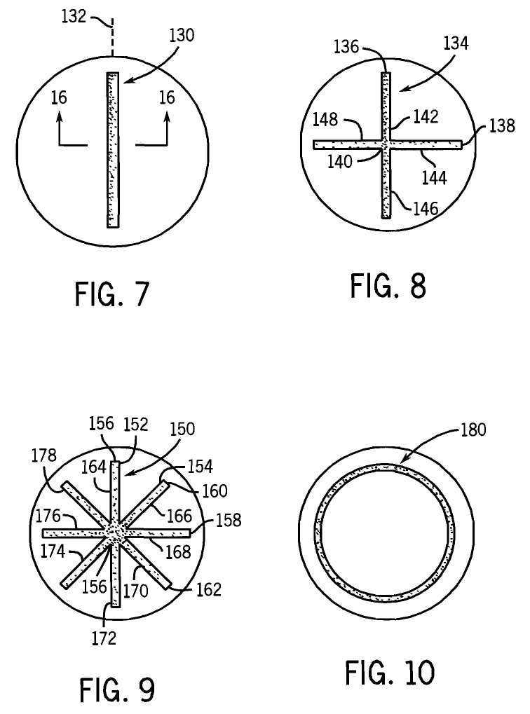

FIG. 7 is a view taken along line 7-7 of FIG. 6 but showing modifications in accordance with the present invention.

FIG. 8 is like FIG. 7 and shows another embodiment.

FIG. 9 is like FIG. 7 and shows another embodiment.

FIG. 10 is like FIG. 7 and shows another embodiment.

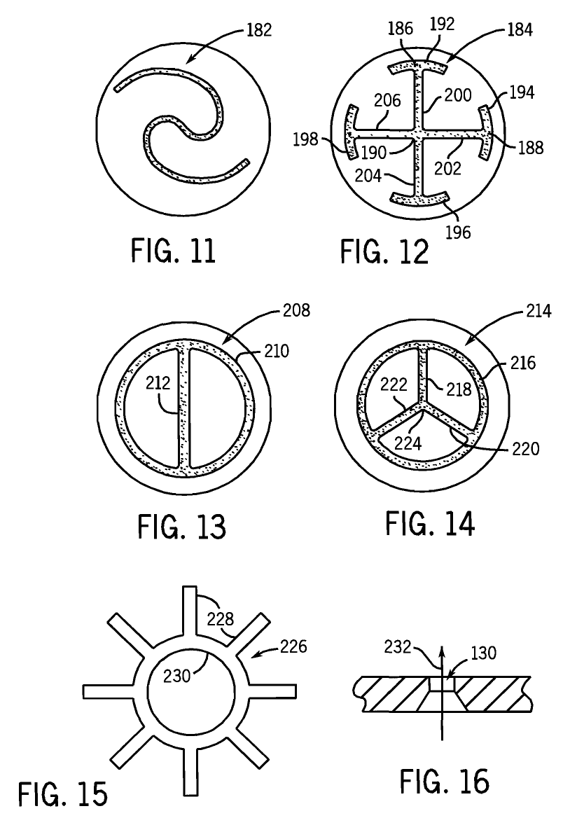

FIG. 11 is like FIG. 7 and shows another embodiment.

FIG. 12 is like FIG. 7 and shows another embodiment.

FIG. 13 is like FIG. 7 and shows another embodiment.

FIG. 14 is like FIG. 7 and shows another embodiment.

FIG. 15 is like FIG. 7 and shows another embodiment.

FIG. 16 is a sectional view taken along line 16-16 of FIG. 7.

### DETAILED DESCRIPTION

### Prior Art

The following description of FIGS. 1-6 is taken from incorporated U.S. Pat. No. 6,290,738.

FIG. 1 shows FIG. 1 shows an inertial gas-liquid separator 10 for removing and coalescing liquid particles from a gas-liquid stream 12, and shown in an exemplary crankcase ventilation separation application for an internal combustion engine 14. In such application, it is desired to vent combustion blow-by gases from crankcase 16 of engine 14. Untreated, these gases contain particulate matter in the form of oil mist and soot. It is desirable to control the concentration of the contaminants, especially if the blow-by gases are to be recirculated back into the engine's air intake system, for example at air intake manifold 18. The oil mist droplets are generally less than 5 microns in diameter, and hence are difficult to remove using conventional fibrous filter media while at the same time maintaining low flow resistance as the media collects and becomes saturated with oil and contaminants.

Separator 10 includes a housing 20 having an inlet 22 for receiving gas-liquid stream 12 from engine crankcase 16, and an outlet 24 for discharging a gas stream 26 to air intake manifold 18. Nozzle structure 28 in the housing has a plurality of nozzles or holes 30 receiving the gas-liquid stream from inlet 22 and accelerating the gas-liquid stream through nozzles 30. An inertial collector 32 in the housing is in the path of the accelerated gas-liquid stream and causes a sharp directional change thereof as shown at 36. Collector 32 has a rough porous collection or impingement surface 34 causing liquid particle separation from the gas-liquid stream of smaller size liquid particles than a smooth non-porous impactor impingement surface and without the sharp cut-off size of the latter. The use of a rough porous collection surface is contrary to typical inertial gas-liquid separators, but is intentional in the present system, for the above noted reasons, and as further noted herein.

The noted rough porous collection surface improves overall separation efficiency including for liquid particles smaller than the cut-off size of a smooth non-porous impactor impingement surface. The rough porous collection surface causes both: a) liquid particle separation from the gas-liquid stream; and b) collection of the liquid particles within the collection surface. The rough porous collection surface has a cut-off size for particle separation which is not as sharp as that of a smooth non-porous impactor impingement surface but improves collection efficiency for particles smaller than the cut-off size as well as a reduction in cut-off size. The rough porous collection surface provides a coalescing medium, such that liquid particles, once captured within the collection surface, will coalesce with other liquid particles in the collection surface, and such that the accelerated gas stream and resultant high velocity of gas at and within the collection surface creates drag forces sufficient to cause captured liquid to migrate to outer edges of the collection surface and shed off of the collector. After the noted sharp directional change, outlet 24 receives the gas stream, as shown at 38, absent the separated liquid particles. Collection surface 34 and nozzles 30 are separated by a gap 40 sufficient to avoid excessive restriction. Housing 20 has a flow path therethrough including a first flow path portion 42 for the gas-liquid stream between inlet 22 and gap 40, and a second flow path portion 44 for the gas stream between gap 40 and outlet 24. The flow path through housing 20 has a directional change in gap 40 at collection surface 34, and another directional change in the noted second flow path portion, as shown at 46.

A pass-through filter 48, FIG. 1, in the noted second flow path portion provides a back-up safety filter trapping liquid particles re-entrained in the gas stream after separation at inertial collector 32. Drain 50 in the housing drains separated fluid from the collector. In FIG. 1, drain 50 drains the separated fluid externally of housing 20 as shown at 52 back to crankcase 16. Drain 50 is gravitationally below and on the opposite side of collector 32 from pass-through filter 48. In FIG. 1, gas stream 26 flows along a vertical axial direction. Filter 48 extends along a radial left-right horizontal span perpendicular to the noted axial vertical direction. The noted radial horizontal span of pass-through filter 48 extends across the entire housing and is parallel to collection surface 34. The gas stream flows radially at 36 along and parallel to collection surface 34 after separation and then turns 90° as shown at 46 and flows through pass-through filter 48 to outlet 24 as shown at 38.

FIG. 2 is similar to FIG. 1 and uses like reference numerals where appropriate to facilitate understanding. In FIG. 2, drain 54 drains separated fluid back to inlet 22. A second pass-through filter 56 in the housing is gravitationally below and on the opposite side of collector 32 from pass-through filter 48 and filters separated liquid from collector 32. Drain 54 drains filtered fluid through pass-through filter 56 to inlet 22.

Drain 54 in FIG. 2 is also a bypass port through which gas-liquid stream 12 may flow to gap 40 without being accelerated through nozzles 30. The gas-liquid stream from inlet 22 thus has a main flow path through nozzles 30 and accelerated through gap 40 against collector 32, and an alternate flow path through filter 56 and bypass port 54 to gap 40. Pass-through filter 56 in the noted alternate flow path traps and coalesces liquid in the gas-liquid stream from inlet 22 to remove liquid from the gas stream supplied to outlet 24 through the noted alternate flow path. Outlet 24 thus receives a gas stream from the noted main flow path with liquid removed by collector 32, and also receives a gas stream from the noted alternate flow path with liquid removed by pass-through filter 56. Inlet 22 is gravitationally below pass-through filter 56. Liquid removed by pass-through filter 56 from the gas-liquid stream in the noted alternate flow path thus drains to inlet 22. Pass-through filter 56 also filters liquid removed from the gas-liquid stream in the noted main flow path by collector 32 and drains such liquid through drain 54 and filter 56 back to inlet 22.

FIG. 3 uses like reference numerals from above where appropriate to facilitate understanding. In FIG. 3, the axial flow of the gas stream through the housing is horizontal. Drain 58 in the housing drains separated fluid from the collector externally of the housing back to crankcase 16. Drain 58 is in the noted second flow path portion 44 and drains separated fluid from collector 32 through pass-through filter 48 such that the latter filters both gas stream 26 and the separated fluid. Drain 58 is between pass-through filter 48 and outlet 24, and is gravitationally below collector 32 and outlet 24 and pass-through filter 48.

FIG. 4 uses like reference numbers from above where appropriate to facilitate understanding. FIG. 4 shows a vertical orientation of gas flow axially through a housing 60 having an inlet 62 for receiving gas-liquid stream 12, and an outlet 64 for discharging gas stream 26. Nozzle structure 66 in the housing has a plurality of nozzles or holes 68 receiving the gas-liquid stream from inlet 62 and accelerating the gas-liquid stream radially horizontally through nozzles 68 and radially through annular gap 70 to impinge annular inertial collector 72. Collector 72 is in the path of the accelerated gas-liquid stream and causes a sharp directional change thereof and has a rough porous collection surface 74, as above. The housing has a vertical axial flow path therethrough including a first flow path portion 76 for the gas-liquid stream between inlet 62 and gap 70, and a second flow path portion 78 for the gas stream between gap 70 and outlet 64. The flow path has a directional change 80 in gap 70 at collection surface 74, and a directional change 82 in flow path portion 76. Each of directional changes 82 and 80 is 90°. Pass-through filter 84 in flow path portion 78 in the housing provides a back-up safety filter trapping liquid particles re-entrained in the gas stream after separation at inertial collector 72. Filter 84 extends horizontally along a radial span relative to the noted vertical axial direction. The radial horizontal span of filter 84 extends across the entire housing and is perpendicular to collection surface 74. After the noted directional change 80, the gas stream flows axially along and parallel to collection surface 74 and then flows axially through pass-through filter 84 to outlet 64. Drain 86 in housing 60 drains separated fluid from collector 72 externally of the housing back to engine crankcase 16. Drain 86 is gravitationally below and on the opposite side collector 72 from pass-through filter 84.

FIG. 5 is similar to FIG. 4 and uses like reference numerals where appropriate to facilitate understanding. In FIG. 5, drain 88 in the housing drains separated fluid from collector 72 to inlet 62. Drain 88 is gravitationally below and on the opposite side of collector 72 from pass-through filter 84. A second pass-through filter 90 in the housing is gravitationally below and on the opposite side of collector 72 from pass-through filter 84 and filters separated fluid from collector 72 drained through drain 88 to inlet 62. The drain is provided by a plurality of holes or ports 88 in nozzle structure 66.

Ports 88 in FIG. 5 are also bypass ports through which gas-liquid stream 12 may flow to gap 70 without being accelerated through nozzles 68. The gas-liquid stream from inlet 62 thus has a main flow path through nozzles 68 and accelerated through gap 70 against collector 72, and an alternate flow path through bypass ports 88 and filter 90 to gap 70. Pass-through filter 90 in the noted alternate flow path traps and coalesces liquid in the gas-liquid stream to remove liquid from the gas stream supplied to outlet 64. Outlet 64 thus receives a gas stream from the noted main flow path with liquid removed by collector 72, and receives a gas stream from the noted alternate flow path with liquid removed by pass-through filter 90. Inlet 62 is gravitationally below pass-through filter 90. Liquid removed by pass-through filter 90 from the gas-liquid stream in the noted alternate flow path thus drains through drain or bypass ports 88 to inlet 62. Pass-through filter 90 also filters liquid removed from the gas-liquid stream in the noted main flow path by collector 72 and drains such liquid back through drain 88 to inlet 62.

FIG. 6 shows an inertial gas-liquid separator 92 for removing and coalescing liquid particles from a gas-liquid stream 94. Housing 92 has an inlet 96 for receiving gas-liquid stream 94, and an outlet 98 for discharging a gas stream 100. Nozzle structure 102 in the housing has a plurality of nozzles 104 receiving the gas-liquid stream from inlet 96 and accelerating the gas-liquid stream through the nozzles. An inertial collector 106 in the housing in the path of the accelerated gas-liquid stream causes a sharp directional change thereof as shown at 108. The collector has a rough porous collection surface 110 causing liquid particle separation from the gas-liquid stream. Drain 112 in the housing drains separated fluid from the collector back to crankcase 16.

Nozzles 104 in FIG. 6 have an upstream entrance opening 114, and a downstream exit opening 116. Entrance opening 114 is larger than exit opening 116. The nozzles have a frusto-conical tapered transition section 118 between the entrance and exit openings. The frusto-conical tapered transition section has an upstream end 120 of a first diameter at entrance opening 114, and has a downstream end 122 of a second diameter smaller than the noted first diameter. Downstream end 122 of frusto-conical tapered transition section 118 is spaced from exit opening 116 by a second transition section 124 of constant diameter equal to the noted second diameter.

In one embodiment, collection surface 34, FIGS. 1-3, 74, FIGS. 4 and 5, 110, FIG. 6, is a fibrous collection surface comprising a plurality of layers of fibers. At least two or three layers of fibers are desirable and provide improved performance. In the preferred embodiment, at least one hundred layers of fibers are provided. The fibers have a diameter at least three times the diameter of the liquid particles to be separated and captured. In preferred form, the fiber diameter is in the range of 50 to 500 microns. For oil mist droplets in the range from 0.3 microns to 3 microns, with a 1.7 micron average, particle separation efficiency improved to 85% mass efficiency with the noted fibrous collection surface, as comparing to 50% mass efficiency for a smooth non-porous collection surface.

In another embodiment, the collection surface is a porous collection surface of porosity between 50% and 99.9%. The average pore size is at least five to ten times the diameter of the liquid particles, and preferably at least 25 to 50 microns.

In another embodiment, the collection surface is a rough collection surface having a roughness measured in peak-to-valley height of at least ten times the diameter of the liquid particles. The peak to valley height is measured parallel to the direction of gas-liquid flow from the nozzles to the collection surface. The peak-to-valley height is preferably at least 10 microns.

### Present Application

The present invention provides an inertial gas-liquid separator, as above, for removing liquid particles from a gas-liquid stream, including a housing such as 92 having an inlet such as 96 for receiving a gas-liquid stream as at 94, and an outlet such as 98 for discharging a gas stream as at 100. A nozzle 130 is provided in the housing, as above, receiving the gas-liquid stream from inlet 96 and accelerating the gas-liquid stream through the nozzle. An inertial impactor collector such as 106 is provided in the housing, as above, in the path of the accelerated gas-liquid stream and causing liquid particle separation from the gas-liquid stream, all as above. The plural nozzles such as 104 of FIG. 6 are replaced in FIG. 7 preferably by an elongated slot as shown at 130. The slot extends along an elongated extension direction 132 transverse to the direction of flow of the gas-liquid stream through the slot, namely out of the page in FIG. 7, which is vertically upwardly in FIG. 6. In one embodiment, slot 130 is a rectilinear slot. In another embodiment, to be described, the slot is a curvilinear slot, FIGS. 10-14. Multiple slots may be used, though in the preferred embodiment, the elongated slot along an elongated extension direction enables the use of only a singular nozzle to replace multiple nozzles such as 30 or 68 or 104.

In FIG. 8, slot 134 has a cross-shape comprising first and second crossbars 136 and 138 intersecting each other at a junction 140 having first, second, third and fourth radial arms 142, 144, 146, 148, respectively, extending radially outwardly from junction 140. First and third radial arms 142 and 146 constitute the noted first crossbar 136. Second and fourth radial arms 144 and 148 constitute the noted second crossbar 138. Crossbars 136 and 138 intersect each other at the mid point of each such that radial arms 142, 144, 146, 148 are of equal length. In the embodiment of FIG. 8, the radial arms are spaced from each other by 90°.

FIG. 9 shows a slot 150 having a multi-cross-shape comprising at least two crosses 152 and 154 meeting at a common junction 156. The multi-cross-shape has first, second, third, and fourth crossbars 156, 158, 160, 162 intersecting each other at common junction 156 having first, second, third, fourth, fifth, sixth, seventh and eighth radial arms 164, 166, 168, 170, 172, 174, 176 and 178 extending radially outwardly from common junction 156. First and fifth radial arms 164 and 172 constitute first crossbar 156. Third and seventh radial arms 168 and 176 constitute second crossbar 158. Second and sixth radial arms 166 and 174 constitute third crossbar 160. Fourth and eighth radial arms 170 and 178 constitute fourth crossbar 162.

In FIG. 10, slot 180 is an annulus.

In FIG. 11, slot 182 has a spiral S-shape.

In FIG. 12, slot 184 has a lobed-shape provided by a cross-shape having first and second crossbars 186 and 188 intersecting each other at a junction 190 and having curvilinear slots 192, 194, 196, 198 transversely crossing respective crossbars. The lobed-shape includes first, second, third and fourth radial arms 200, 202, 204 and 206 extending radially outwardly from junction 190. First and third radial arms 200 and 204 constitute first crossbar 186. Second and fourth radial arms 202 and 206 constitute second crossbar 188. First, second, third and fourth curvilinear slots are provided as noted at 192, 194, 196 and 198. First curvilinear slot 192 arcuately crosses first radial arm 200. Second curvilinear slot 194 arcuately crosses second radial arm 202. Third curvilinear slot 196 arcuately crosses third radial arm 204. Fourth curvilinear slot 198 arcuately crosses fourth radial arm 206.

In FIG. 13, slot 208 is an annulus at 210 bisected by a rectilinear slot 212 extending along the diameter thereof.

In FIG. 14, slot 214 is an annulus at 216 having first, second and third radial arms 218, 220 and 222 extending radially inwardly therefrom to a common junction 224.

In various of the embodiments such as shown in FIGS. 8, 9, 12, 14, the slot is provided by a plurality of spokes extending outwardly from a common junction, wherein the spokes and the junction lie in a plane transverse to the direction of flow of the gas-liquid stream therethrough, for example spokes 142, 144, 146, 148 and junction 140 in FIG. 8, and for example spokes 164, 166, 168, 170, 172, 174, 176, 178 and junction 156 in FIG. 9, and for example spokes 200, 202, 204, 206 and junction 190 in FIG. 12, and for example spokes 218, 220, 222, and junction 224 in FIG. 14.

In various further embodiments, rectilinear geometries may be combined with curvilinear geometries. For example, FIG. 15 shows nozzle slot 226 having both rectilinear and curvilinear segments 228 and 230, respectively. The slot is provided by an annulus at 230 having a plurality of radial arms 228 extending radially therefrom. In one embodiment, radial arms 228 extend radially outwardly from annulus 230 in a starburst shape. FIG. 15 is one example of combining FIGS. 9 and 10. Other combinations may be used, for example combinations of FIGS. 12 and 10, FIGS. 11 and 10, and various other combinations, including rectilinear and curvilinear segments.

It is preferred that each of the respectively noted slots has a cross-sectional frusto-conical shape as shown in FIG. 16 in a cross-section taken parallel to the direction of flow 232 therethrough, which direction of flow 232 is vertically upwardly in FIGS. 6 and 16, and is out of the page in FIGS. 7-15. The various nozzle structures shown in FIGS. 7-15 may be used with a rough porous collection surface as in FIGS. 1-6 above, e.g. at 34, 74, 110, or may be used with other types of collection surfaces such as smooth non-porous impactor impingement surfaces. The disclosed nozzle structure may be used in various orientations, including as shown in FIGS. 1, 2, or as shown in FIG. 3, or as shown in FIGS. 4, 5, or as shown in FIG. 6, or in various other orientations, combinations, and environments.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. An inertial gas-liquid impactor separator for removing liquid particles from a gas-liquid stream, comprising a housing having an inlet for receiving a gas-liquid stream, and an outlet for discharging a gas stream, a nozzle in said housing receiving said gas-liquid stream from said inlet and accelerating said gas-liquid stream through said nozzle, an inertial impactor collector in said housing in the path of said accelerated gas-liquid stream and causing liquid particle separation from said gas-liquid stream, wherein said nozzle is an elongated slot.

2. The inertial gas-liquid impactor separator according to claim 1 wherein said slot extends along an elongated extension direction transverse to the direction of flow of said gas-liquid stream therethrough.

3. The inertial gas-liquid impactor separator according to claim 2 wherein said slot comprises a rectilinear slot.

4. The inertial gas-liquid impactor separator according to claim 2 wherein said slot comprises is a curvilinear slot.

5. The inertial gas-liquid impactor separator according to claim 2 wherein said slot has a cross-shape.

6. The inertial gas-liquid impactor separator according to claim 5 wherein said cross-shape comprises first and second crossbars intersecting each other at a junction having first, second, third and fourth radial arms extending radially outwardly from said junction, said first and third radial arms constituting said first crossbar, said second and fourth radial arms constituting said second crossbar.

7. The inertial gas-liquid impactor separator according to claim 6 wherein said first and second crossbars intersect each other at the midpoint of each such that said first, second, third and fourth radial arms are of equal length, and wherein said radial arms are spaced from each other by 90°.

8. The inertial gas-liquid impactor separator according to claim 2 wherein said slot has a multi-cross-shape comprising at least two crosses meeting at a common junction.

9. The inertial gas-liquid impactor separator according to claim 8 wherein said multi-cross-shape comprises first, second, third and fourth crossbars intersecting each other at said common junction having first, second, third, fourth, fifth, sixth, seventh and eighth radial arms extending radially outwardly from said common junction, said first and fifth radial arms constituting said first crossbar, said third and seventh radial arms constituting said second crossbar, said second and sixth radial arms constituting said third crossbar, said fourth and eighth radial arms constituting said fourth crossbar.

10. The inertial gas-liquid impactor separator according to claim 2 wherein said slot is an annulus.

11. The inertial gas-liquid impactor separator according to claim 2 wherein said slot has a spiral shape.

12. The inertial gas-liquid impactor separator according to claim 2 wherein said slot has an S-shape.

13. The inertial gas-liquid impactor separator according to claim 2 wherein said slot has a lobed-shape comprising a cross-shape comprising first and second crossbars intersecting each other at a junction and having curvilinear slots transversely crossing said crossbars.

14. The inertial gas-liquid impactor separator according to claim 13 wherein said lobed-shape comprises first, second, third and fourth radial arms extending radially outwardly from said junction, said first and third radial arms constituting said first crossbar, said second and fourth radial arms constituting said second crossbar, and comprising first, second, third and fourth said curvilinear slots, said first curvilinear slot arcuately crossing said first radial arm, said second curvilinear slot arcuately crossing said second radial arm, said third curvilinear slot arcuately crossing said third radial arm, said fourth curvilinear slot arcuately crossing said fourth radial arm.

15. The inertial gas-liquid impactor separator according to claim 2 wherein said slot comprises an annulus bisected by a rectilinear slot extending along the diameter thereof.

16. The inertial gas-liquid impactor separator according to claim 2 wherein said slot comprises an annulus having first, second and third radial arms extending radially inwardly therefrom to a common junction.

17. The inertial gas-liquid impactor separator according to claim 2 wherein said slot comprises a plurality of spokes extending outwardly from a common junction, said spokes and said junction lying in a plane transverse to the direction of flow of said gas-liquid stream therethrough.

18. The inertial gas-liquid impactor separator according to claim 2 wherein said slot has both rectilinear and curvilinear segments.

19. The inertial gas-liquid impactor separator according to claim 18 wherein said slot comprises an annulus having a plurality of radial arms extending radially therefrom.

20. The inertial gas-liquid impactor separator according to claim 19 wherein said radial arms extend radially outwardly from said annulus in a starburst shape.

21. The inertial gas-liquid impactor separator according to claim 2 wherein said slot has a cross-sectional frustoconical shape in a cross-section taken parallel to the direction of flow of said gas-liquid stream therethrough.
